(19) United States
(12) Patent Application Publication
(10) Pub. No.: US 2004/0216056 A1
(43) Pub. Date: Oct. 28, 2004

(54) System and method for supporting scrolling of contents in a display

(75) Inventor: David A. Tootill, Mercer Island, WA (US)

Correspondence Address: BAKER BOTTS L.L.P., 2001 ROSS AVENUE, SUITE 600, DALLAS, TX, 75201-2980, US

(73) Assignee: Computer Associates Think, Inc.

(21) Appl. No.: 10/421,509

(22) Filed: Apr. 22, 2003

(51) Int. Cl. G09G 5/00

(52) U.S. Cl. 715/786

(57) ABSTRACT

A method includes generating a display comprising contents to be presented to a user and a scrollbar. The scrollbar is operable to allow the user to scroll through a first portion of the contents of the display. The user is unable to scroll a second portion of the contents of the display out of view of the user using the scrollbar. The method also includes communicating the display for presentation to the user.

### TECHNICAL FIELD

This disclosure relates generally to the field of computer systems, and more particularly to a system and method for supporting scrolling of contents in a display.

### BACKGROUND

A web-based application typically resides on a server that is accessible by multiple client computers. The web-based application typically generates displays that are communicated to the client computers for presentation to users. The displays, such as web pages, often include scrollbars allowing the user to scroll through the contents of the displays. A problem with conventional web-based applications is that the scrollbars typically cause important information to scroll out of view of the user. Also, space in the display is often reserved for a scrollbar, even when the scrollbar is not needed in the display.

### SUMMARY

This disclosure provides a system and method for supporting scrolling of contents in a display. In particular, a scrollbar is positioned so that a user may scroll through a portion of the display without the requirement of putting that portion into a frame. At least one other portion of the display, such as a heading of a document, remains visible to the user and does not scroll out of view of the user. Also, if a scrollbar is not needed in the display, space need not be reserved in the display for a scrollbar.

In one embodiment, a method includes generating a display comprising contents to be presented to a user and a scrollbar. The scrollbar is operable to allow the user to scroll through a first portion of the contents of the display. The user is unable to scroll a second portion of the contents of the display out of view of the user using the scrollbar. The method also includes communicating the display for presentation to the user.

In another embodiment, a method includes receiving a display comprising contents to be presented to a user. The method also includes determining whether to include a scrollbar in the display. The scrollbar is operable to allow the user to scroll through a first portion of the contents of the display. The user is unable to scroll a second portion of the contents of the display out of view of the user using the scrollbar. In addition, the method includes presenting the display to the user.

### BRIEF DESCRIPTION OF THE DRAWINGS

For a more complete understanding of this disclosure, reference is now made to the following descriptions, taken in conjunction with the accompanying drawings, in which:

FIG. 1 is an exemplary block diagram illustrating an example system for supporting scrolling of contents in a display according to one embodiment of this disclosure;

FIGS. 2A through 2D are exemplary block diagrams illustrating an example display that can be scrolled according to one embodiment of this disclosure;

FIGS. 3A and 3B are exemplary block diagrams illustrating another example display that can be scrolled according to one embodiment of this disclosure;

FIGS. 4A and 4B are exemplary block diagrams illustrating the internal structure of a web page according to one embodiment of this disclosure;

FIG. 5 is an exemplary flow diagram illustrating an example method for allowing a user to scroll contents in a display according to one embodiment of this disclosure; and

FIG. 6 is an exemplary flow diagram illustrating an example method for supporting scrolling of contents in a display according to one embodiment of this disclosure.

### DETAILED DESCRIPTION OF EXAMPLE EMBODIMENTS

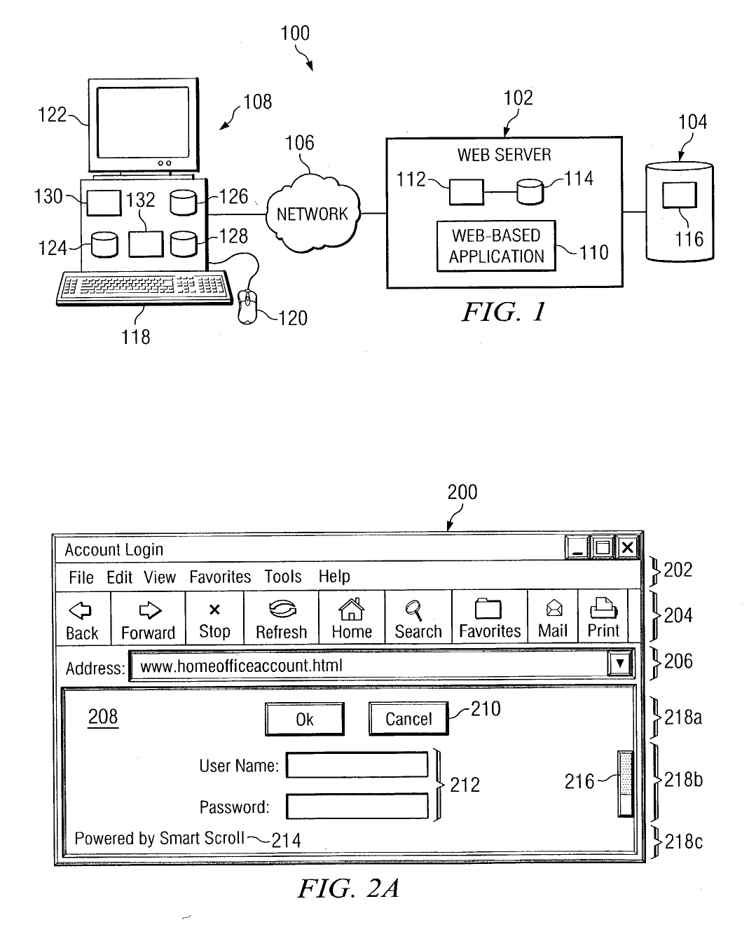

FIG. 1 is an exemplary block diagram illustrating an example system 100 for supporting scrolling of contents in a display according to one embodiment of this disclosure. In the illustrated embodiment, system 100 includes a web server 102, a database 104, a network 106, and a host computer 108. Other embodiments of system 100 may be used without departing from the scope of this disclosure.

In one aspect of operation, host 108 may access server 102 and invoke execution of a web-based application 110. In one embodiment, application 110 generates displays, such as web pages, and communicates the displays to host 108 over network 106. In another embodiment, application 110 communicates information to host 108, and host 108 generates displays containing the information. The displays include content, such as text and pictures, that can be scrolled by a user of host 108 using a scrollbar in the display. In a particular embodiment, the scrollbar allows the user to scroll through a portion of the content in the display, and at least one other portion of the display cannot be scrolled out of view of the user. This may be useful, for example, when the display includes buttons that can be selected by the user. By not allowing the buttons to scroll out of view of the user, the buttons remain visible and can be selected at any time by the user.

In the illustrated embodiment, server 102 is coupled to database 104 and network 106. In this specification, the term “couple” refers to any direct or indirect communication between two or more components, whether or not those components are in physical contact with one another. Also, the term “communication” refers to communication between physically separate components or between components within a single physical unit. Server 102 performs one or more functions to provide services to host 108. For example, server 102 could execute one or more web-based applications 110 on behalf of one or more hosts 108. Server 102 may include any hardware, software, firmware, or combination thereof operable to provide services to host 108. In the illustrated embodiment, server 102 includes at least one processor 112 and at least one memory 114, although other embodiments of server 102 could also be used.

Application 110 represents any suitable application, such as a set of instructions, procedures, functions, objects, classes, instances, and related data adapted for implementation in a suitable computer language such as C, C++, Java, or other appropriate language. Application 110 may provide any suitable functionality in system 100, including generating displays for presentation at host 108 and/or providing data to host 108 for use in generating displays.

Database 104 is coupled to server 102. Database 104 stores and facilitates retrieval of information used by server 102. For example, database 104 may store application information 116, which represents information received from a host 108 to be processed by an application 110. Database 104 may include any hardware, software, firmware, or combination thereof operable to store and facilitate retrieval of information. Database 104 may also use any of a variety of data structures, arrangements, and compilations to store and facilitate retrieval of information.

Network 106 is coupled to server 102 and host 108. Network 106 facilitates communication between components of system 100. For example, network 106 may communicate Internet Protocol (IP) packets, frame relay frames, Asynchronous Transfer Mode (ATM) cells, or other suitable information between network addresses. Network 106 may include one or more local area networks (LANs), metropolitan area networks (MANs), wide area networks (WANs), all or a portion of a global network such as the Internet, or any other communication system or systems at one or more locations.

Host 108 is coupled to network 106. Host 108 may perform any of a variety of functions in system 100. For example, host 108 could allow a user to submit a request to invoke execution of an application 110 at server 102. Host 108 could also allow the user to transmit information 116 to be processed by server 102 and receive information to be displayed to the user. Host 108 may include any hardware, software, firmware, or combination thereof operable to communicate with server 102.

In the illustrated example, host 108 includes a keyboard 118, a mouse 120, an output device 122, random access memory (RAM) 124, read-only memory (ROM) 126, a CD, DVD, hard drive, or other storage and retrieval device or devices 128, and one or more processors 130. Host 108 also executes a browser 132, which can be any suitable browser. As particular examples, browser 132 could represent Microsoft Internet Explorer 5.0 or greater, Netscape 6.2 or greater, or Mozilla 1.0 or greater. Output device 122 may, for example, include a video display, a printer, a disk drive, a plotter, a speaker, or other suitable output device.

In one aspect of operation, application 110 and/or host 108 generates displays, such as one or more web pages, for presentation to a user of host 108. As an example, application 110 can generate and communicate hypertext markup language (HTML) code to host 108. Host 108 can use the HTML code to generate and display a web page to a user of host 108, such as through the use of web browser 132. In this example, the web pages include content, which could represent any suitable information for display to a user. For example, a web page displayed by host 108 could include text, menus, buttons, notebook tabs, forms, lists, or other or additional content in one or multiple frames. The user could perform any suitable action using the web page, such as lowering a menu, selecting a button, or typing information into a form.

In one embodiment, host 108 may be unable to display all of the contents of a web page simultaneously. This may occur, for example, when a window displaying the web page is not big enough for host 108 to display all of the contents of the web page. When this occurs, host 108 may insert a scrollbar in the display. The user could use keyboard 118 and/or mouse 120 to scroll through a portion of the web page using the scrollbar. In this specification, the term “scroll” refers to changing the visible content of a display by removing at least some visible content from the display and/or adding additional visible content to the display. As particular examples, the scrolling could occur in an up-down orientation where the content displayed moves up and down and/or a side-to-side orientation where the content displayed moves right and left. In one embodiment, the scrollbar allows the user to scroll through only a portion of the content of the web page. At least one other portion, such as portions at the top and bottom of the web page, remains visible to the user. In this example, these portions cannot be scrolled out of view of the user using the scrollbar.

Host 108 could also resize the scrollbar and/or remove the scrollbar when it is not needed in the display. For example, the user at host 108 may be able to resize the window in which the web page is being displayed. In particular, the user may be able to increase the size of the window so that more or all of the contents of the web page can be displayed. The user could also decrease the size of the window so that less of the contents of the web page can be displayed. Further, the user may be able to hide portions of the web page or reveal hidden portions of the web page, which change the amount of content being displayed. When these or other events occur, host 108 may determine whether a scrollbar is needed in the display and where the top of the scrollbar should be in relation to the content of the web page. If no scrollbar is required, any previously inserted scrollbar is removed from the display and the space occupied by the scrollbar is available for content. If a scrollbar is needed in the display, host 108 can determine a suitable size for the scrollbar. In this way, the scrollbar can be used when needed in the display and can be removed when not needed.

Although FIG. 1 illustrates one example embodiment of a system 100 for supporting scrolling of contents in a display, various changes may be made to FIG. 1. For example, while FIG. 1 illustrates one host 108 coupled to network 106 and accessing server 102, any number of hosts 108 can be used in system 100. Also, server 102 could execute any suitable number of applications 110. Further, server 102 could represent any suitable computing device.

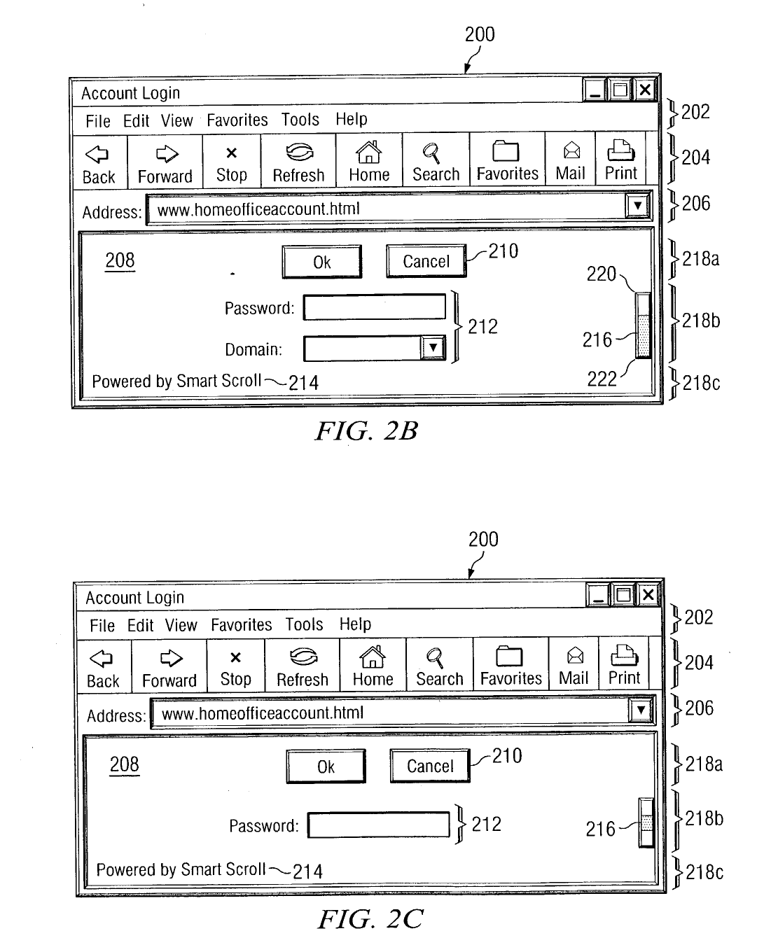

FIGS. 2A through 2D are exemplary block diagrams illustrating an example display that can be scrolled according to one embodiment of this disclosure. In particular, FIGS. 2A through 2D illustrate an example web page displayed by a web browser. The web page illustrated in FIGS. 2A through 2D could, for example, be generated by server 102 and displayed by host 108 of FIG. 1. The web page in FIGS. 2A through 2D is for illustration only. Other web pages could be used in system 100. Also, while the web page may be described as being generated by and used in system 100 of FIG. 1, the web page could be generated and used by any other suitable system.

In FIG. 2A, a window 200 displays a web page representing an interface that allows a user to log onto an application, such as application 110 in server 102. In the illustrated example, window 200 includes a menu 202, a button bar 204, an address bar 206, and a content display area 208. Menu 202 allows the user to navigate a list of web browser functions available for invocation. Button bar 204 represents buttons that can invoke the same or different functions of browser 132. Address bar 206 identifies the current web address being viewed by the user of host 108.

Content display area 208 displays some or all of the contents of a web page. In the illustrated example, content display area 208 displays buttons 210, an entry form 212, and text 214. Buttons 208 represent functions that can be invoked by the user, such as functions of application 110. Edit form 212 represents a mechanism used by a user to enter information, which may be supplied to application 110. Text 214 represents text displayed to the user in the web page.

As shown in FIG. 2A, window 200 further includes a scrollbar 216. Scrollbar 216 allows a user to scroll through at least a portion of the contents of the web page displayed in content display area 208. In this example, the scrollbar 216 allows the user to scroll through edit form 212. The scrollbar 216 does not allow the user to scroll buttons 210 or text 214 out of view of the user of host 108. In this way, buttons 210 and text 214 remain visible to the user, even when the user uses scrollbar 216 to scroll up and down in edit form 212. In effect, this divides content display area 208 into three different portions 218a-218c. The visible content contained in portion 218b changes as the user uses scrollbar 216. The content contained in portions 218a and 218c remain visible to the user, even when the visible content in portion 218b changes. Because scrollbar 216 may be used to scroll through a portion of a web page, scrollbar 216 may be referred to as a “partial page” scrollbar.

FIG. 2B illustrates the web page after the user scrolls down edit form 212 using scrollbar 216. In this case, some content is removed from portion 218b of content display area 208, and additional content is added to portion 218b. The remaining portions 218a, 218c of content display area 208 remain unchanged. This may allow, for example, content such as buttons 210 to remain visible to the user at all times.

In a particular embodiment, the characteristics of the scrollbar in window 200 are controlled by one or more JavaScript functions. For example, the web page may be defined by HTML code. In this example, one or more startScrollbar( ) JavaScript function calls and an endScrollbar( ) JavaScript function call may be used in the HTML code. Each startScrollbar( ) JavaScript function call specifies a possible beginning location 220 of the scrollbar 216 in window 200. The endScrollbar( ) JavaScript function call controls the ending location 222 of the scrollbar 216 in window 200. As a particular example, each startScrollbar( ) JavaScript function call has the effect of creating an HTML DIV element having an overflow:auto style, which defines a block of content in the web page. The endScrollbar( ) JavaScript function call closes all the DIV elements created by startScrollbar( ) JavaScript function calls. In an example system, multiple startScrollbar( ) JavaScript function calls and one endScrollbar( ) JavaScript function call can be contained in the HTML code. In this embodiment, the scrollbar 216 starts at the starting location 220 defined by the last instance of a startScrollbar( ) JavaScript function call within the visible portion of the web page and ends at the ending location 222 defined by the endScrollbar( ) JavaScript function call.

FIG. 2C illustrates the web page after the user resizes the window 200 containing the web page. As shown in FIG. 2C, the user resizes the window 200 to be smaller than in FIGS. 2A and 2B. As a result, only one field in the edit form 212 can be displayed.

In a particular embodiment, an adjScrollbarHeight( ) JavaScript function relocates and resizes the scrollbar as desired, or hides it if it is no longer needed. The adjScrollbarHeight( ) JavaScript function may be invoked in an on Resize HTML event handler, which occurs when the window 200 containing the web page is resized. The adjScrollbarHeight( ) JavaScript function may also be invoked when another JavaScript function hides an element in the web page or makes a hidden element visible.

FIG. 2D illustrates the web page after the user again resizes the window 200 containing the web page. As shown in FIG. 2D, the user resizes the window 200 to be large enough so that all contents of the web page can be displayed. In particular, all of edit form 212 can be displayed in window 200. When all contents of the web page can be displayed in window 200, host 108 need not include scrollbar 216 in window 200. Also, the area 224 of window 200 that normally contains scrollbar 216 may, but need not, be used to display other content.

Although FIGS. 2A through 2D illustrate example embodiments of a display used in system 100, various changes may be made to FIGS. 2A through 2D. For example, the web page shown in FIGS. 2A through 2D is for illustration only. Other web pages or displays having other contents and arrangements may be used. Also, the web pages displayed to the user could include other or additional features and are not limited to the content shown in FIGS. 2A through 2D. As an example, the web page could include multiple scrollbars 216 and/or multiple frames having one or more scrollbars 216 in one or more of the frames.

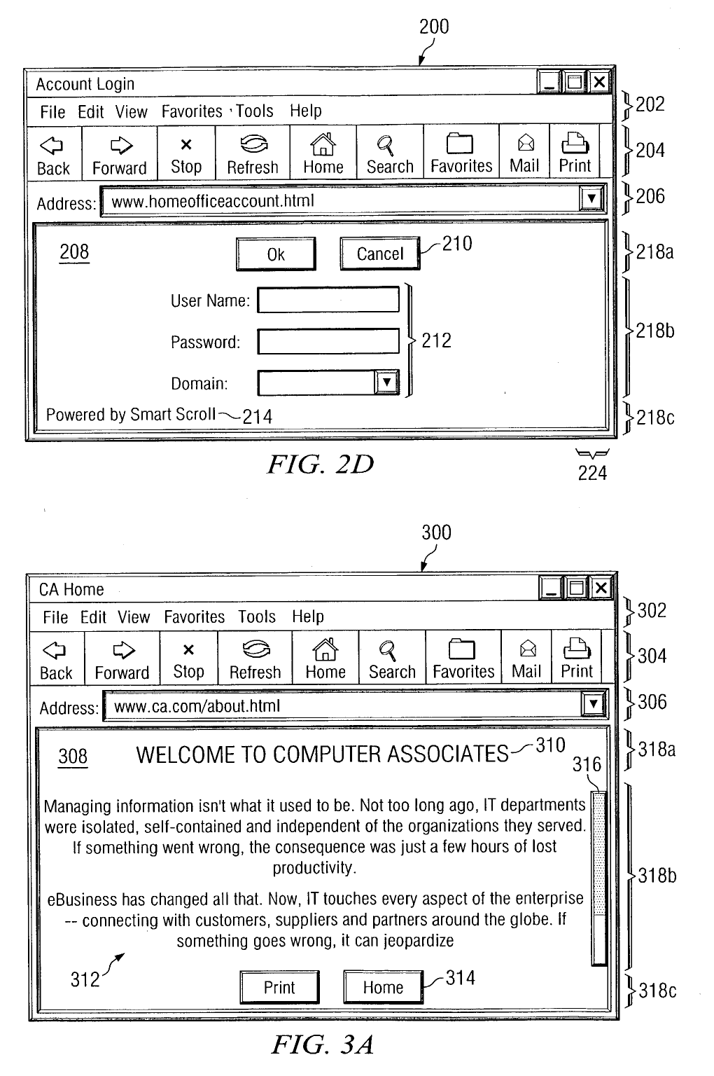

FIGS. 3A and 3B are exemplary block diagrams illustrating another example display that can be scrolled according to one embodiment of this disclosure. In particular, FIGS. 3A and 3B illustrate another example web page displayed by a web browser. The web page illustrated in FIGS. 3A and 3B could, for example, be generated by server 102 and displayed by host 108 of FIG. 1. The web page in FIGS. 3A and 3B is for illustration only. Other web pages could be used in system 100. Also, while the web page may be described as being generated by and used in system 100 of FIG. 1, the web page could be generated and used by any other suitable system.

In FIG. 3A, a window 300 displays a web page containing a document, such as a document created by application 110 in server 102. In the illustrated example, window 300 includes a menu 302, a button bar 304, an address bar 306, and a content display area 308. Content display area 308 displays some or all of the contents of the web page. In the illustrated example, content display area 308 includes a title 310, text 312, and buttons 314.

As shown in FIG. 3A, window 300 further includes a scrollbar 316. Scrollbar 316 allows a user to scroll through the text 312 displayed in window 300. The scrollbar 316 does not allow the user to scroll title 310 or buttons 314 out of view of the user of host 108, and title 310 and buttons 314 remain visible to the user. This divides content display area 308 into three different portions 318a-318c. The content shown in portions 318a and 318c does not change when the user uses scrollbar 316, while the content of portion 318b does.

FIG. 3B illustrates the web page after the user resizes the window 300 so that all of the text 312 can be displayed in window 300. As shown in FIG. 3B, host 108 need not include scrollbar 316 in window 300 when all content of the web page can be displayed in window 300. The area 324 previously occupied by scrollbar 316 can then be used to display other content in window 300. In the illustrated example, the use of area 324 to display text 312 allows host 108 to display more text 312 in window 300. The area 324 need not be reserved for a scrollbar 316 that is not available for use.

Although FIGS. 3A and 3B illustrate another example embodiment of a display used in system 100, various changes may be made to FIGS. 3A and 3B. For example, the web page shown in FIGS. 3A and 3B is for illustration only. Other web pages or displays having other contents and arrangements may be used. Also, the web pages displayed to the user could include other or additional features and are not limited to the content shown in FIGS. 3A and 3B. As an example, the web page could include multiple scrollbars 316 and/or multiple frames having one or more scrollbars 316 in one or more of the frames.

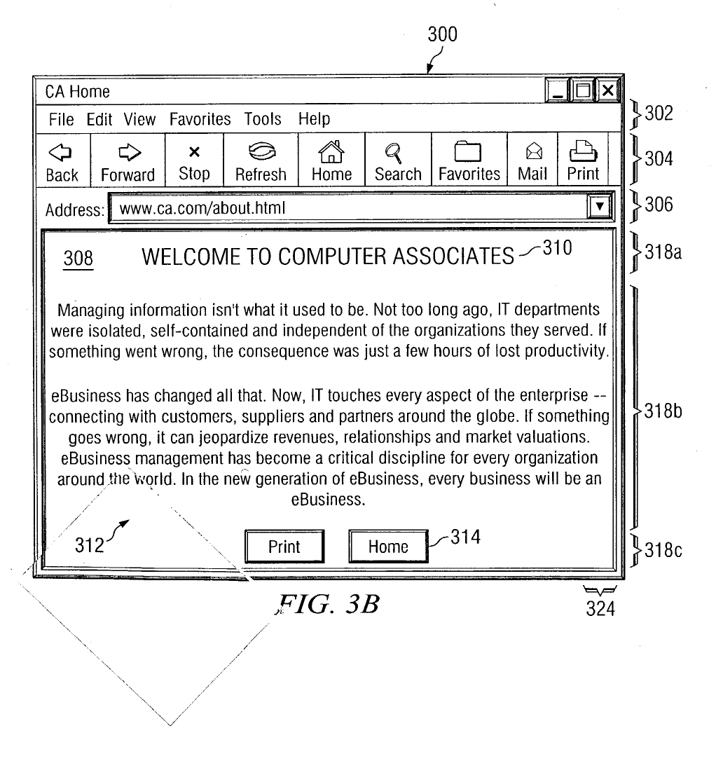

FIGS. 4A and 4B are diagrams illustrating example internal structures of a web page constructed according to one embodiment of this disclosure. In each example, the page contains data that would take 1000 pixels of browser window 400 height to display in full. In the example web page, there are three scrollbar divisions. The first HTML division, ScrollDiv0 402, containing substantially all of the page, is 1000 pixels high and is created by a startScrollbar( ) JavaScript function call at the beginning of the data. The page also contains a second startScrollbar( ) JavaScript function call 500 pixels into the data. This function call creates the second HTML DIV ScrollDiv1 404. The example web page contains a third startScrollbar( ) JavaScript function call 200 pixels further in the data. This creates a third HTML DIV ScrollDiv2 406. An endScrollbar( ) JavaScript function call at the end of the page closes both HTML DIV elements.

FIG. 4A shows the results of displaying this web page in a browser window 400 that is 650 pixels high. The startScrollbar( ) JavaScript function call beginning ScrollDiv1 404 is the last one in the visible portion of the page, so the scrollbar begins at the top of ScrollDivl 404 and extends 150 pixels to the bottom of the browser window. The user uses the scrollbar to scroll the contents of ScrollDivl 404 (including ScrollDiv2 406) into the browser window. The portion of the web page preceding ScrollDivl 404 does not scroll.

FIG. 4B illustrates the results of resizing browser window 400 to 900 pixels high. In this example, the startScrollbar( ) JavaScript function call beginning ScrollDiv2 406 is the last one in the visible portion of the page. Accordingly, the scrollbar begins at the top of ScrollDiv2 406 and extends 200 pixels to the bottom of browser window 400. The portion of the web page preceding ScrollDiv2 406 (including the top portion of ScrollDivl 404) does not scroll. Repositioning of the scrollbar is performed by the adjScrollbarHeight( ) JavaScript function, which is invoked by an on Resize event handler.

It should be understood that FIGS. 4A-B are for example purposes only and may include any web page in any size web browser 400. According to particular embodiments, the author of the web page need not count pixels, but may merely insert one or more startScrollbar( ) calls at desired places within the content of the web page.

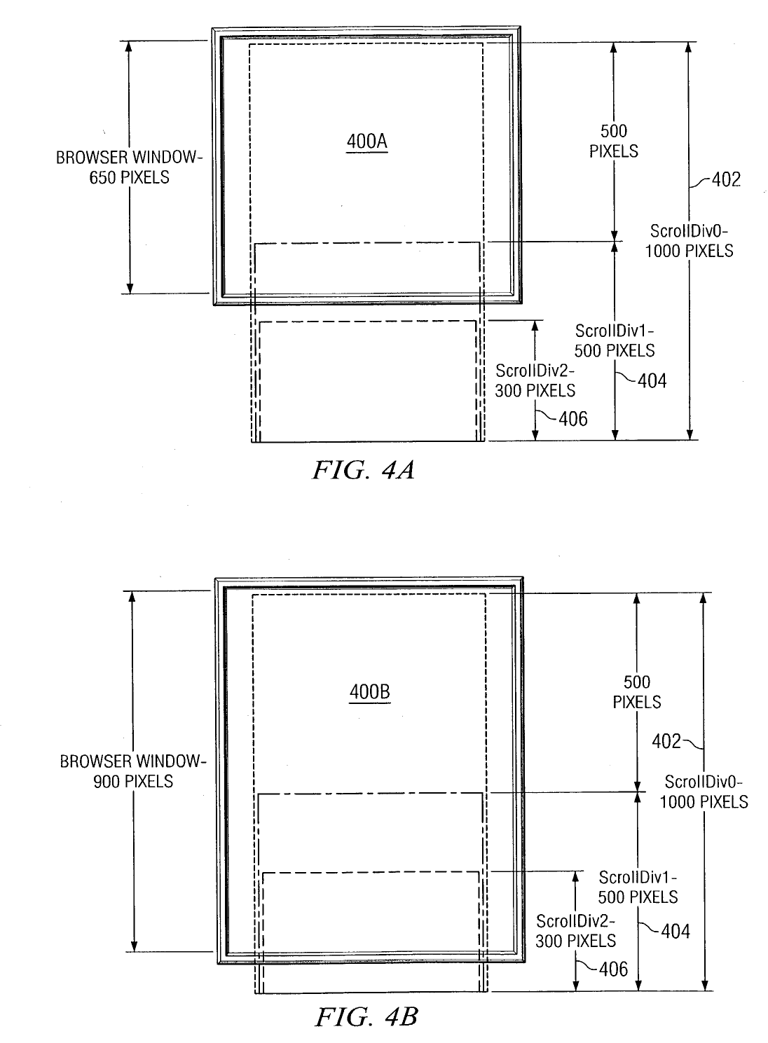

FIG. 5 is an exemplary flow diagram illustrating an example method 500 for allowing a user to scroll contents in a display according to one embodiment of this disclosure. Method 500 may be described with respect to system 100 of FIG. 1. Method 500 could also be used by any other system.

A user communicates a request for a web page to a server at step 502. This may include, for example, a host 108 communicating a request for a web page to server 102 over network 106. The user receives a web page containing at least one partial page scrollbar at step 504. This may include, for example, host 108 receiving HTML code defining the web page from server 102 over network 106. As a particular example, the HTML code could include one or more startScrollbar( ) JavaScript function calls and one or more endScrollbar( ) JavaScript function calls defining the location of the partial page scrollbar.

The web page is displayed to the user at step 506. This may include, for example, browser 132 at host 108 displaying the web page on output device 122. This may also include host 108 displaying the web page in a window of host 108. This may further include host 108 executing the startScrollbar( ) and endScrollbar JavaScript functions that are invoked by the function calls contained in the HTML code.

Host 108 determines whether the size of the window in which the web page is displayed allows all contents of the web page to be displayed at step 508. As one example, at least a portion of the content of the web page may be hidden by the user. In this example, this may include browser 132 determining whether the non-hidden elements in the web page can be displayed in the window.

If not, host 108 inserts the partial page scrollbar in the web page. Host 108 determines the size of the scrollbar to be included in the web page at step 510. This may include, for example, browser 132 identifying the starting location and ending location of the scrollbar. This may also include browser 132 executing the adjScrollbarHeight( ) JavaScript function to determine the height of the scrollbar. Host 108 inserts the scrollbar into the web page at step 512. This may include, for example, browser 132 displaying the scrollbar at the identified starting location and ending location. If the window is large enough to contain the contents of the web page, no scrollbar needs to be inserted in the window. In this case, the area normally reserved for the scrollbar can be used for other web page content.

Host 108 determines whether the user resizes the window in which the web page is displayed or changes the displayed contents of the web page at step 514. This may include, for example, browser 132 determining whether the user changes the size of the window 200, 300 in which the web page is displayed. This may also include browser 132 identifying when the user hides an element in the web page or makes a previously hidden element visible. When one or more of these events occur, host 108 returns to step 508 to determine whether the window 200, 300 can display all of the non-hidden content.

Although FIG. 5 illustrates one example of a method 500 for allowing a user to scroll contents in a display, various changes may be made to FIG. 5. For example, other types of displays can be used in place of a web page. Also, while FIG. 5 illustrates host 108 receiving a display from server 102, host 108 could receive information from server 102 and generate the display.

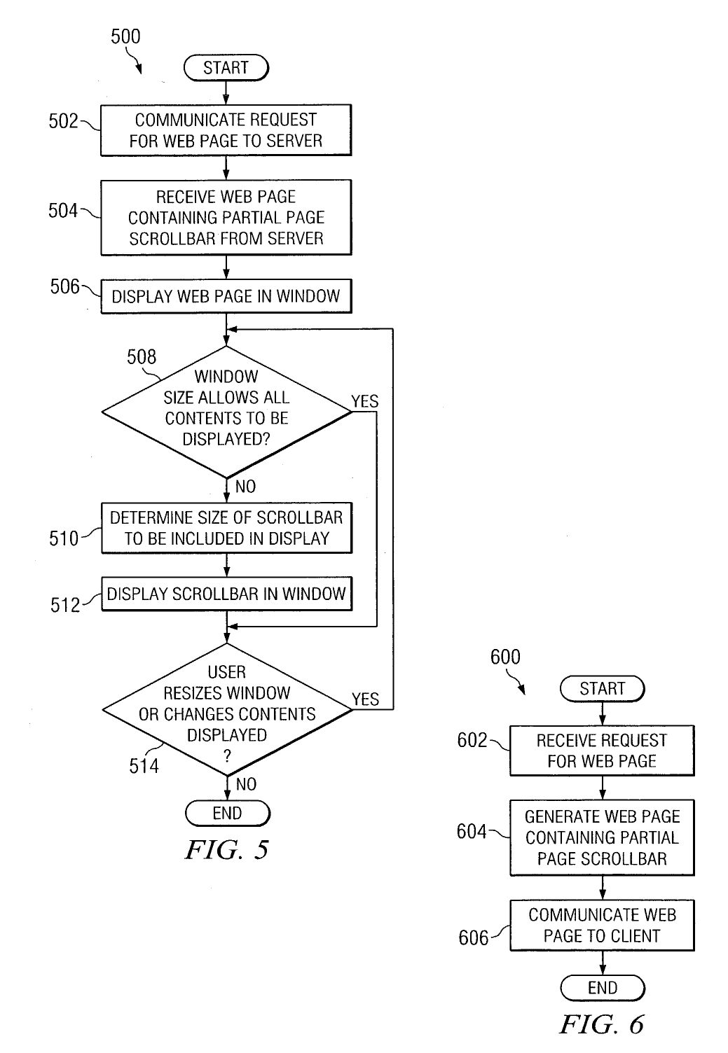

FIG. 6 is an exemplary flow diagram illustrating an example method 600 for supporting scrolling of contents in a display according to one embodiment of this disclosure. Method 600 may be described with respect to system 100 of FIG. 1. Method 600 could also be used by any other system.

Server 102 receives a request for a web page at step 602. This may include, for example, server 102 receiving the request from host 108 over network 106. Server 102 generates a web page containing at least one partial page scrollbar at step 604. This may include, for example server 102 generating HTML code for the web page. This may also include server 102 inserting one or more startScrollbar( ) JavaScript function calls and one or more endScrollbar( ) JavaScript function calls in the HTML code. Server 102 communicates the web page to a client computer at step 606. This may include, for example, server 102 communicating the HTML code to host 108 over network 106.

Although FIG. 6 illustrates one example of a method 600 for supporting scrolling of contents in a display, various changes may be made to FIG. 6. For example, other types of displays can be used in place of a web page. Also, while FIG. 6 illustrates server 102 generating a web page for host 108, server 102 could also communicate information to host 108 and allow host 108 to generate the display.

While this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
generating a display comprising contents to be presented to a user and a scrollbar, the scrollbar operable to allow the user to scroll through a first portion of the contents of the display, the user unable to scroll a second portion of the contents of the display out of view of the user using the scrollbar; and
communicating the display for presentation to the user.

2. The method of claim 1, further comprising:
determining whether a window in which the display is presented to the user has a size that allows all of the first portion of the display to be presented; and
presenting the scrollbar to the user when the window size does not allow all of the first portion of the display to be presented.

3. The method of claim 2, further comprising removing the scrollbar from the display when the window size allows all of the first portion of the display to be presented.

4. The method of claim 2, wherein determining whether the window size allows all of the first portion of the display to be presented comprises detecting an event that alters the amount of contents displayed in the window.

5. The method of claim 4, wherein the event comprises one of resizing the window, hiding a portion of the contents, and revealing a previously hidden portion of the contents.

6. The method of claim 5, wherein detecting the resizing of the window comprises detecting an on Resize event handler.

7. The method of claim 1, further comprising receiving a request for the display.

8. The method of claim 1, wherein one of a server and a client computer is operable to generate and communicate the display.

9. The method of claim 1, wherein the scrollbar allows the user to scroll up and down or left and right through the first portion of the contents of the display.

10. The method of claim 1, wherein generating the display comprises generating HTML code containing at least two JavaScript function calls, one function call invoking a first function that establishes a starting location of the scrollbar, another function call invoking a second function that establishes an ending location of the scrollbar.

11. The method of claim 1, wherein generating the display comprises:
receiving HTML code containing at least two JavaScript function calls;
executing a first JavaScript function that establishes a starting location of the scrollbar; and
executing a second JavaScript function that establishes an ending location of the scrollbar.

12. The method of claim 1, wherein resizing the browser window or hiding or revealing form elements comprises executing a JavaScript function to reposition the scrollbar.

13. A system, comprising:
a memory operable to store information defining a display, the display comprising contents to be presented to a user and a scrollbar, the scrollbar operable to allow the user to scroll through a first portion of the contents of the display, the user unable to scroll a second portion of the contents of the display out of view of the user using the scrollbar; and
one or more processors collectively operable to:
generate the display; and
communicate the display for presentation to the user.

14. The system of claim 13, wherein the one or more processors are further collectively operable to:
determine whether a window in which the display is presented to the user has a size that allows all of the first portion of the display to be presented; and
present the scrollbar to the user when the window size does not allow all of the first portion of the display to be presented.

15. The system of claim 14, wherein the one or more processors are further collectively operable to remove the scrollbar from the display when the window size allows all of the first portion of the display to be presented.

16. The system of claim 14, wherein the one or more processors are collectively operable to determine whether the window size allows all of the first portion of the display to be presented by detecting an event that alters the amount of contents displayed in the window.

17. The system of claim 16, wherein the event comprises one of resizing the window, hiding a portion of the contents, and revealing a previously hidden portion of the contents.

18. The system of claim 13, wherein the one or more processors are collectively operable to generate the display by generating HTML code containing at least two JavaScript function calls, one function call invoking a first function that establishes a starting location of the scrollbar, another function call invoking a second function that establishes an ending location of the scrollbar.

19. The system of claim 13, wherein the one or more processors are collectively operable to generate the display by:
receiving HTML code containing at least two JavaScript function calls;
executing a first JavaScript function that establishes a starting location of the scrollbar; and
executing a second JavaScript function that establishes an ending location of the scrollbar.

20. Logic embodied on at least one computer readable medium and operable when executed to:
generate a display comprising contents to be presented to a user and a scrollbar, the scrollbar operable to allow the user to scroll through a first portion of the contents of the display, the user unable to scroll a second portion of the contents of the display out of view of the user using the scrollbar; and
communicate the display for presentation to the user.

21. A system, comprising:
means for generating a display comprising contents to be presented to a user and a scrollbar, the scrollbar operable to allow the user to scroll through a first portion of the contents of the display, the user unable to scroll a second portion of the contents of the display out of view of the user using the scrollbar; and
means for communicating the display for presentation to the user.

22. A method, comprising:
receiving a display comprising contents to be presented to a user;
determining whether to include a scrollbar in the display, the scrollbar operable to allow the user to scroll through a first portion of the contents of the display, the user unable to scroll a second portion of the contents of the display out of view of the user using the scrollbar; and
presenting the display to the user.

23. The method of claim 22, wherein determining whether to include the scrollbar comprises determining whether a window in which the display is presented to the user has a size that allows all of the first portion of the display to be presented.

24. The method of claim 23, further comprising including the scrollbar in the display when the window size does not allow all of the first portion of the display to be presented.

25. The method of claim 23, wherein determining whether to include the scrollbar comprises detecting an event that alters the amount of contents displayed in the window.
